(19) United States
(12) Patent Application Publication
(10) Pub. No.: US 2002/0000246 A1
(43) Pub. Date: Jan. 3, 2002

(54) Suction-type siphon for a flushing device

(75) Inventor: Maarten Rost, Jona (CH)

Correspondence Address: William H. Logsdon, 700 Koppers Building, 436 Seventh Avenue, Pittsburgh, PA, 15219-1818, US

(73) Assignee: GEBERIT TECHNIK AG

(21) Appl. No.: 09/895,701

(22) Filed: Jun. 29, 2001

(30) Foreign Application Priority Data
Jun. 30, 2000 (CH) 1298/00

(51) Int. Cl. F16L 55/24

(52) U.S. Cl. 137/247.41

(57) ABSTRACT

The suction-type siphon has a channel which runs from an inlet opening to an outlet opening and has a bend for receiving sealing water. After the said bend, as seen in the direction of flow, the channel has a depression causing the formation of a sump which constricts the channel for the passage of air. The constriction by means of the sump makes filling possible with little water, but does not impede the passage of solid objects. A urinal having the suction-type siphon according to the invention can be flushed with little flushing water, for example, less than one liter of water.

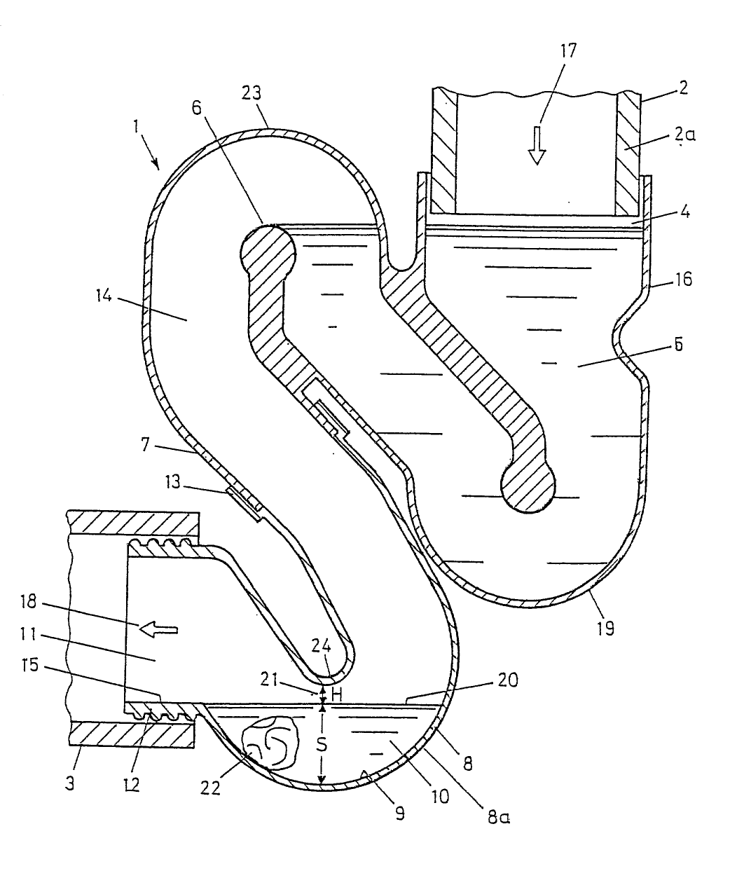

### CROSS-REFERENCE TO RELATED APPLICATION

This application claims priority to Swiss Application No. 1298/00 filed Jun. 30, 2000, which is herein incorporated by reference in its entirety.

### BACKGROUND OF THE INVENTION

1. Field of the Invention

The invention relates to a suction-type siphon for a flushing device, in particular a urinal, having an inlet opening which receives the flushing water, having an outlet opening which is to be connected to a waste-disposal conduit and through which the flushing water exits, and having a channel which runs from the inlet opening to the outlet opening and has a bend for receiving sealing water.

2. Description of the Prior Art

Suction-type siphons of the type mentioned are used in particular for urinals. With these siphons, the siphon effect has long been used to empty them. The filling of the siphon is achieved by a constriction of the cross section of the stench trap at the outlet. Once filled, the siphon effect is initiated. The suction is interrupted by the entry of air into the channel of the siphon. Refilling takes place, for example, by means of a cistern or a flushing valve.

In a suction-type siphon for urinals, the channel has a comparatively small cross section. A constriction at the outlet would substantially increase the risk here of blockage, since, as it is known, numerous solid objects, for example cigarette stubs, are also thrown into urinal bowls. Up to now, urinals have therefore required comparatively high amounts of flushing water in the region of approximately two to three liters.

The invention is based on the object of providing a suction-type siphon of the type mentioned which requires substantially less flushing water without increasing the risk of blockage.

### SUMMARY OF THE INVENTION

In the case of a suction-type siphon according to the invention, the object is achieved in that downstream, or after the said bend as seen in the direction of flow, the channel has a depression causing the formation of a sump which constricts the channel for the passage of air. With the suction-type siphon according to the invention, the sump is therefore used only for constricting the passage for air. This constriction makes filling possible more rapidly and therefore with less flushing water. However, the passage cross section for solid objects, for example cigarette stubs, is not constricted by the sump. The constriction caused by the sump is therefore effective only for the passage of the air. Tests have shown that, using the suction-type siphon according to the invention, a urinal can be flushed clean with substantially less water. Flushing clean is possible, in particular, with a liter of water or even less. The suction-type siphon according to the invention is provided, in particular, for a urinal, but applications in other flushing devices and, in particular, in a water closet, are also conceivable.

According to a development of the invention, the depression for the sump is particularly advantageously formed by a deflecting bow between one limb and the outlet end. This deflecting bow is preferably a lower deflecting bow with the outlet opening forming the overflow edge which determines the level of the sump. This deflecting bow can be produced as a separate shaped piece and can be connected to the remaining body of the suction-type siphon by means of a plug-in connection.

Further advantageous features emerge from the dependent patent claims, the following description and the drawing.

### BRIEF DESCRIPTION OF THE DRAWING

The single FIGURE shows a section through a suction-type siphon according to the invention.

### DETAILED DESCRIPTION OF THE INVENTION

The suction-type siphon 1 shown in the FIGURE comprises two blow-molded parts 8 and 16 which are connected to each other by a plug-in connection 13. An inlet opening 4, which is directed vertically upwards, is connected to a discharge connection piece 2a of a sanitary article, in particular of a urinal bowl 2. The flushing water leaves the sanitary article 2 in the direction of the arrow 17 and passes into a channel 14 leading into a waste-disposal conduit 3 at an outlet opening 11. The flushing water leaves the outlet opening 11 in the direction of the arrow 18.

Arranged after the inlet opening 4 is a deflecting bend or bow 19 which receives sealing water 5 and forms a stench trap. The level of the sealing water 5 is determined by an overflow edge 6 of a further bend 23. After the edge 6, a limb 7 leads downwards to a further deflecting bend or bow 8a. This deflecting bow 8a forms a depression 9 in which flushing water causes the formation of a sump 10. The level of the sump 10 is determined by a lower surface 15 of an outlet connection piece 12 within the water-disposal conduit 3. The level 20 of the sump 10 is situated below a wall 24 of the deflecting bow 8a in such a manner that a passage opening 21 for air is formed between the level 20 and the wall 24. The height H of the passage 21 is substantially smaller than the height S of the sump 10. The cross section for the passage of air is therefore substantially reduced by the sump 10.

The constriction of the cross section in the region of the deflecting bow 8a therefore concerns only the passage of air. In contrast, the channel 14 is not constricted in the region of the deflecting bow 8a for solid objects 22. The comparatively large object 22 which is indicated can therefore be readily flushed out.

During flushing, filling takes place comparatively rapidly, since the sump 10 impedes the passage of air in the region of the deflecting bow 8a. After filling, emptying takes place in a conventional manner by the siphon effect, in which case the water of the sump 10, together with any objects 22, is also flushed out here. When the siphon is refilled, for example via a cistern (not shown), the sump 10 is formed again and the sealing water 5 resupplied.

Having described a presently preferred embodiment of the invention, it is to be understood that it may be otherwise embodied within the scope of the appended claims.

I claim:

1. A suction-type siphon for a flushing device, comprising:
an inlet opening for receiving flushing water;
an outlet opening configured to be connected to a waste-disposal conduit and through which the flushing water exits; and
a channel which runs from the inlet opening to the outlet opening and has a bend for receiving sealing water, wherein downstream of said bend, the channel has a depression forming a sump which constricts the channel forming a constricted passage for the passage of air.

2. The suction-type siphon according to claim 1, wherein the depression is arranged directly upstream of the outlet opening.

3. The suction-type siphon according to claim 1, wherein the outlet opening is formed by an outlet connection piece running substantially horizontally.

4. The suction-type siphon according to claim 2, wherein the outlet opening is formed by an outlet connection piece running substantially horizontally.

5. The suction-type siphon according to claim 1, wherein the depression is formed by a deflecting bow between a limb and the outlet opening.

6. The suction-type siphon according to claim 2, wherein the depression is formed by a deflecting bow between a limb and the outlet opening.

7. The suction-type siphon according to claim 3, wherein the depression is formed by a deflecting bow between a limb and the outlet opening.

8. The suction-type siphon according to claim 1, wherein a level of the sump is determined by an outlet connection piece.

9. The suction-type siphon according to claim 2, wherein a level of the sump is determined by an outlet connection piece.

10. The suction-type siphon according to claim 3, wherein a level of the sump is determined by an outlet connection piece.

11. The suction-type siphon according to claim 4, wherein a level of the sump is determined by an outlet connection piece.

12. The suction-type siphon according to claim 5, wherein a level of the sump is determined by an outlet connection piece.

13. The suction-type siphon according to claim 1, wherein a depth of the sump is substantially greater than a width of the constricted passage.

14. The suction-type siphon according to claim 2, wherein a depth of the sump is substantially greater than a width of the constricted passage.

15. The suction-type siphon according to claim 3, wherein a depth of the sump is substantially greater than a width of the constricted passage.

16. The suction-type siphon according to claim 4, wherein a depth of the sump is substantially greater than a width of the constricted passage.

17. The suction-type siphon according to claim 5, wherein a depth of the sump is substantially greater than a width of the constricted passage.

18. The suction-type siphon according to claim 1, wherein the flushing device is a urinal.

19. The suction-type siphon according to claim 2, wherein the flushing device is a urinal.

20. The suction-type siphon according to claim 3, wherein the flushing device is a urinal.
